(19) United States
(12) Patent Application Publication
(10) Pub. No.: US 2018/0050930 A1
(43) Pub. Date: Feb. 22, 2018

(54) CRYSTALLIZER FOR WATER RECLAMATION

(71) Applicant: Naveed Aslam, Houston, TX (US)

(72) Inventor: Naveed Aslam, Houston, TX (US)

(21) Appl. No.: 15/238,298

(22) Filed: Aug. 16, 2016

(51) Int. Cl. C02F 1/22; B01D 9/00; C02F 1/52

(52) U.S. Cl. CPC C02F 1/22; B01D 9/0009; C02F 2103/10; C02F 2001/5218; C02F 1/5236

(57) ABSTRACT

A crystallizer for use in treating produced water is disclosed. The crystallizer is a combination of a source of nitrogen in fluid communication with at least one connecting tube which is in fluid communication with a chamber which is in fluid communication with a discharge tube. The produced water from an oil and gas operation is fed into the crystallizer which will separate out contaminants from the water producing fresh water.

### BACKGROUND OF THE INVENTION

Hydraulic fracturing is becoming a desirable method for extracting hydrocarbons. However, this method is being given scrutiny by public and regulatory agencies due to their extensive requirement for and consumption of water.

This problem is exacerbated in certain regions of the United States because there is a water shortage to contend with. The Permian Basin in Texas is one such area so there is a continuous need for methods that use water more efficiently in the hydraulic fracturing operations.

Typically the produced water that is recovered is characterized by unusually high percentages of dissolved solids (TDS) in the range of 50,000 to 600,000 parts per million which makes these types of water not suitable for reverse osmosis units. Evaporative crystallization (EC) technologies are also not desirable due to their low efficiencies due to the heat of evaporation of water

The present invention provides for a liquid nitrogen (LIN) based crystallizer and its use in reclaiming water from oil and gas produced water streams.

### SUMMARY OF THE INVENTION

In one embodiment of the invention, there is disclosed a crystallizer comprising: a source of nitrogen in fluid communication with at least one connecting tube which is in fluid communication with a chamber which is in fluid communication with a discharge tube.

The source of nitrogen can be both in the form of gaseous nitrogen (GAN) or liquid nitrogen (LIN) and can be from any readily adaptable supply source. The source is typically a nozzle which will be in fluid communication with a first connecting or draft tube.

A source of feed water is also in fluid communication with the first connecting or draft tube and will supply the water that is to be treated by the crystallizer such as produced water from an oil and gas operation.

The at least one connecting tube can be a plurality of connecting tubes. Critical to the operation of the crystallizer is that each successive connecting tube is greater in diameter than the one preceding it in fluid communication with the source of feed water and gaseous nitrogen. This requirement provides for the gaseous nitrogen, as it rises through the connecting tubes, to change velocity and allow for the separation of crystals (ice versus salt). The gaseous nitrogen will also provide agitation to the at least one connecting tube.

The at least one connecting tube is in fluid communication with a chamber where the at least one connecting tube will be present in the chamber proper. The at least one connecting tube will thereby terminate in the chamber. The chamber is designed to hold a fluid such as the water that is being treated by the crystallizer. The terminating at least one connecting tube will discharge water in the form of a water spray into the chamber. This water spray will help convert the ice crystals or slush that arrives at the terminating at least one connecting tube and will convert these ice crystals or slush into fresh water which is free of the contaminants that were present in the water when it was first fed to the at least one connecting tube. This fresh water is recovered through a pipe that is present in the chamber where it can be reused in the oil and gas operation or for other uses.

The source of the gaseous nitrogen and liquid nitrogen is air. For purposes of the present invention, the gaseous nitrogen or liquid nitrogen will be supplied on a movable compact skid through an installed tank. Alternatively, other inert gases such as carbon dioxide, helium and mixtures thereof can be used instead of nitrogen.

The nozzle is typically designed to avoid clogging while rapidly cooling and assisting in the crystallization of ice crystals from the water feed through the expansion of liquid nitrogen.

The crystallizer is typically 2 to 3 feet in diameter and has a height of 6 to 8 feet. Typically the number of connecting tubes can vary by throughput requirement and can be two, four, or eight depending on the operator's desired throughput.

The flow of the gas will be continuous.

The successive increase in the diameter of the connecting tubes is attributed in part based on the principles of terminal falling velocity of salt and ice crystals. This is represented by the following formula:

U_{Terminal Salt Crystal}=K_{f}*Squrt((Density of Salt Crystal−Density of Nitrogen Fluid)/(Density of Nitrogen Fluid))

Here K_{f} is the friction coefficient based on the drag and load factor of flows. The U_{Terminal Salt Crystal} of a salt gives velocity of nitrogen gas flowing from the downward to the upward direction and at that velocity of nitrogen the salt crystal will be suspended in the up flowing stream of nitrogen thus attaining the balance in a flow stream. If the nitrogen upwards velocity increases, the salt crystal will be carried out upward and if the velocity decrease, then this salt crystal will settle downwards due to the predominant effects of gravity being larger than the inertial effects of the flowing nitrogen stream.

Similarly for ice crystals, the following equation applies:

U_{Terminal Ice Crystal}=K_{f}*Squrt((Density of Ice Crystal−Density of Nitrogen Fluid)/(Density of Nitrogen Fluid))

This provides the equilibrium velocity of nitrogen to stabilize the ice crystals in an upwards flow.

On average, the density of ice crystals could be taken at 2.71 gm/cm³ and density of ice crystals at 0° C. could be taken at 0.9167 gm/cm³. So for a given fluid load and system and fluid friction effects, the terminal velocity of salt crystals will be larger than ice crystals.

Therefore, the diameter of a connecting tube can be calculated as follows:

Diameter=sqrt(4*A/3.14)=Volumetric flow rater of fluid/Terminal falling velocity.

As such, in the case of salt crystals, the cross-sectional area and hence the diameter of the tube will be smaller compared to ice crystals for achieving the equilibrium in the upwards nitrogen flow. This principle is exploited to achieve the separation between the salt and the water. At the bottom of the draft tube, the diameters are smaller and configured in such a way that the salt crystals settle down from the nitrogen flow, while the water crystals are carried upwards. In addition to having a gross separation between the salt and water crystals, this device could also be designed to achieve the separation between different salts due to the differences in their densities thus getting relatively pure salts which could be recovered and sold in the open market.

This design of a tapered draft tube provides a lower OPEX and CAPEX option for separating salt crystals from water wherein the same fluid, i.e., nitrogen which is used to create the crystallization effect is also utilized to achieve separation between different salts and water crystals. This design addresses the difficulties previously encountered with EFC based crystallizer due to having to separate unit operations for salt-water crystal separations and the necessary energy required to achieve such separation.

The various components of the crystallizer unit could be made from plastics or polymeric materials or ordinary steel coated with fluoro polymers. Since this is a low temperature design for water reclamation there is little likelihood of scaling and fouling effects and therefore the unit does not require more expensive material further lowering the overall CAPEX for the unit.

Previous attempts at commercialization of indirect crystallizers to treat high total dissolved solids water were less successful due to the high CAPEX and OPEX involved in the separation of ice and salt crystals as well as the cooling loop and refrigerant compressor design.

The present invention avoids these difficulties because the separation of ice and salt is performed in the same unit using the same fluid thereby lowering CAPEX and OPEX by intensifying energy but also mass exchange in one unit.

Further the crystallizer of the present invention has a lower energy requirement compared to distillation or evaporative crystallizers as the latent heat of fusion of ice is only one seventh that of the latent heat of vaporization.

The lower operating temperatures further result in minimizing scaling and corrosion effects from the water present in the crystallizer chamber. This allows the operator to use lower cost materials of construction.

The high surface area by the direct contact between the produced water and liquid nitrogen results in a greater heat transfer coefficient.

The design per the present invention allows for no pretreatment of the produced water before being treated in the crystallizer.

The present invention further provides for the recovery of salts in near pure form allowing for their reuse or sale for use in other applications.

The present invention provides for a modular and movable crystallizer allowing for the unit to be moved to where there is a need to treat produced water.

The present invention further provides a high turn down ratio or TDR. This reflects the maximum capacity to minimum capacity in terms of flow so a unit with good TDR is desirable as when the feed flow changes the unit can adjust and still perform the desired work without upset the operability of the unit.

### BRIEF DESCRIPTION OF THE DRAWINGS

FIG. 1 is a schematic of a crystallizer as described in the present invention.

FIG. 2 is a schematic of the interaction of two or more crystallizers.

### DETAILED DESCRIPTION OF THE INVENTION

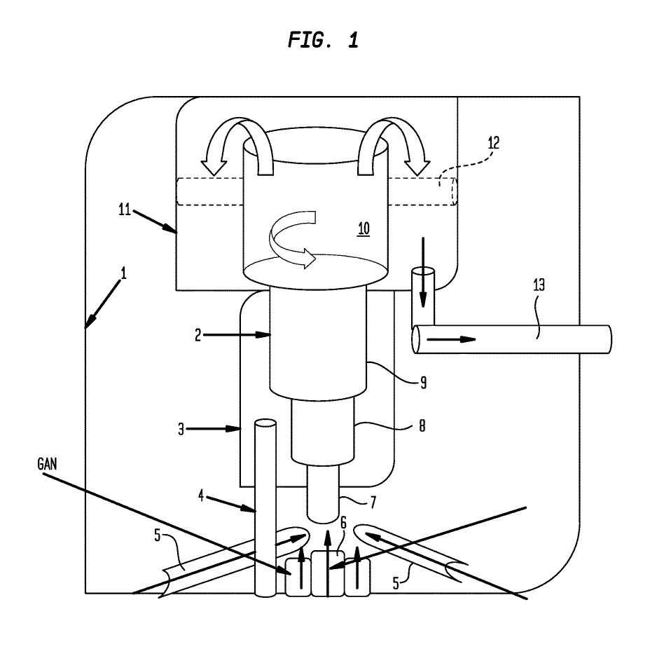

FIG. 1 shows a low-energy, direct contact crystallizer that can be employed for reclaiming produced water. The main crystallizer housing 1 is designed to crystallize the incoming produced water stream 5 into salt and ice crystals through the use of a cryogenic fluid such as liquid nitrogen 6. The crystallizer will also separate the salt and water crystals through a multi-diameter draft tube 2 from the top of the draft tube 2 to a chamber 11 where through a water spray 12 the crystals are converted into fresh water stream and this reclaimed water stream is removed through discharge pipe 13.

Liquid nitrogen and gaseous nitrogen (GAN) are both fed through line 6. They both provide cooling required for the eutectic freeze crystallization of the produced water. The gaseous streams also provide energy required for agitation and through the multi-diameter draft tube 2 provides separation of water crystals from salt solution and salt crystals.

As such, three effects are achieved, namely heat transference, inducing agitation and separation without a pump or agitator motor being present.

The draft tube 2 is divided into several sections of increasing diameter as the flow of fluid progresses upwards. The LIN and/or GAN are fed through nozzle 6 into connecting tube 7 which is fluidly connected to nozzle 6. Connecting tube 7 is fluidly connected to connecting tube 8 which is larger in diameter than connecting tube 7. Connecting tube 8 fluidly connects to connecting tube 9 which is greater in diameter than connecting tube 8. For purposes of FIG. 1, connecting tube 9 fluidly connects to connecting tube 10 which is larger in diameter than connecting tube 9.

As the GAN rises through the draft tube 2 which comprises the connecting tubes 7, 8 and 9, its velocity changes and decreases because of the increase in diameter through the respective connecting tubes. This decrease in velocity will lead to a separation in the crystals formed (ice crystals versus salt crystals) and the ice crystals, being lighter will require a lower terminal falling velocity. The salt crystals being heavier will require a higher terminal falling velocity. So as the GAN rises along the draft tube 2, the heavy crystals of salt will settle down and the lighter ice crystals will be directed to the spray chamber 11 where they are sprayed with a portion of the portion of fresh water and withdrawn as reclaimed water stream 13.

The nozzle 6 is designed to fluidly connect to the first connecting tube 7 and to feed either or both GAN and LIN to the connecting tube 7. Feed water is also fed to connecting tube 7 through line 5 which is shown as two separate feed lines in fluid communication with connecting tube 7. This feed water through line 5 can be the water that is going to be subject to treatment such as the produced water from an oil and gas operation.

A chamber 3 is present to collect the salt crystals. Pipe 4 which is present in the bottom of chamber 3 will assist in removing the salt crystals out of the crystallizer.

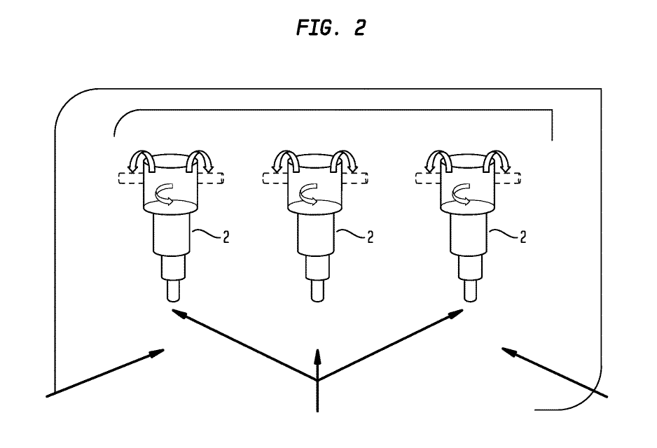

FIG. 2 is a schematic representation of more than one crystallizer working in conjunction with each other. This schematic simply shows the crystallizer as described with respect to the description of FIG. 1 and particularly the draft tube 2 for three crystallizers. This demonstrates that the present invention can address greater flow rates by increasing the number of draft tube assemblies to two or three depending upon the increased flow rate. This also allows for the present invention to be similar to traditional membrane based reverse osmosis units for flow rates.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what we claim is:

1. A crystallizer comprising a source of nitrogen in fluid communication with at least one connecting tube which is in fluid communication with a chamber which is in fluid communication with a discharge tube.

2. The crystallizer as claimed in claim 1 wherein the nitrogen is gaseous nitrogen and liquid nitrogen.

3. The crystallizer as claimed in claim 1 wherein the source of nitrogen is in fluid communication with at least one connecting tube by a nozzle.

4. The crystallizer as claimed in claim 1 wherein the at least one connecting tube is a plurality of connecting tubes.

5. The crystallizer as claimed in claim 1 wherein when a plurality of connecting tubes is present each successive connecting tube is greater in diameter than the connecting tube preceding it.

6. The crystallizer as claimed in claim 1 wherein a source of feedwater is in fluid communication with the at least one connecting tube.

7. The crystallizer as claimed in claim 6 wherein the feedwater is produced water from an oil and gas operation.

8. The crystallizer as claimed in claim 7 wherein the feedwater and gaseous nitrogen rise through the at least one connecting tube.

9. The crystallizer as claimed in claim 1 wherein the gaseous nitrogen will change velocity it rises through the at least one connecting tube.

10. The crystallizer as claimed in claim 9 wherein the nitrogen provides agitation inside of the at least one connecting tube.

11. The crystallizer as claimed in claim 1 wherein salt crystals and ice crystals separate in the at least one connecting tube.

12. The crystallizer as claimed in claim 1 wherein the at least one connecting tube is present in the chamber.

13. The crystallizer as claimed in claim 1 wherein the chamber holds a fluid.

14. The crystallizer as claimed in claim 1 wherein water is sprayed from the connecting tube into the chamber.

15. The crystallizer as claimed in claim 1 wherein the water sprayed contains ice crystals.

16. The crystallizer as claimed in claim 15 wherein the discharge tube discharges water.

17. The crystallizer as claimed in claim 1 wherein salts are recovered from the at least one connecting tube.

18. The crystallizer as claimed in claim 1 wherein the crystallizer is mounted on a skid.

19. The crystallizer as claimed in claim 1 wherein the flow of nitrogen is continuous.
